(19) United States
(12) Patent Application Publication
(10) Pub. No.: US 2007/0148469 A1
(43) Pub. Date: Jun. 28, 2007

(54) Encapsulation composition for pressure signal transmission and sensor

(76) Inventors: Feng-Po Tseng, Taoyuan City (TW); Kuo-Chan Chiou, Tainan City (TW); Tzong-Ming Lee, Hsinchu City (TW); Syh-Yuh Cheng, Chiudon Township (TW); Chih-Wei Hsu, Chang Hwa City (TW)

Correspondence Address: J. C. Patents, Inc., Suite 250, 4 Venture, Irvine, CA, 92618, US

(21) Appl. No.: 11/374,697

(22) Filed: Mar. 13, 2006

(30) Foreign Application Priority Data
Dec. 26, 2005 (TW) 94146473

(51) Int. Cl. B32B 27/38; B32B 27/04; C08L 63/00; B32B 37/00

(52) U.S. Cl. 428/413; 523/400

(57) ABSTRACT

An encapsulation composition for pressure signal transmission including a flexible and low modulus epoxy resin as a substance in combination with plastic balls with pressure signal transmission properties as filler is provided. Therefore, the pressure signal is transmitted by utilizing the property of easy deformation of the flexible epoxy resin under pressure. And the effect of signal transmission is enhanced by the contact between plastic balls. The encapsulation composition is used in a sensor for transmitting pressure signals. The encapsulation composition is hydrophobic, so an electronic device of the sensor can be protected against moisture or water to extend its lifetime. Compared with traditional sensors using liquid for transmitting pressure signal, this sensor using solid encapsulation composition has advantages such as easy production and processing.

### CROSS-REFERENCE TO RELATED APPLICATION

This application claims the priority benefit of Taiwan application serial no. 94146473, filed on Dec. 26, 2005. All disclosure of the Taiwan application is incorporated herein by reference.

### BACKGROUND OF THE INVENTION

1. Field of the Invention

The present invention relates to an encapsulation composition and a sensor. More particularly, the present invention relates to an encapsulation composition for pressure signal transmission and a sensor.

2. Description of Related Art

Along with the evolution of science and technology, sensors are being developed towards miniaturization, higher integration, multi-functional, intelligent, and systematic. Moreover, by application of advanced technologies such as Micro-Electro-Mechanical Systems (MEMS) and micron/nanometers in sensors, and with rapid development of novel sensitive materials, various sensors have been applied in various industries, such as information/communication/consumption electronics, industrial production, biomedical health care, environment protection and public security, national defense, farming, forestry, and fishery, astronavigation, chemistry, photo-electricity and biochemistry, etc.

On the other hand, sensors will have a wider application field with their miniaturization. However, correspondingly, the lifetime of sensors will be shorter and shorter, increasing the lifetime of sensors and inexpensive sensors are highly desirable. Among these, the method of fabricating sensors including sensors—packaging and testing (the cost of both approximately in an amount of above 50% of total product cost) will be crucial production technology.

A pressure sensor detects the value of gas or liquid pressure undertaken (or contacted) with electronic precision sensing by using a pressure-sensing device. Therefore, a pressure-sensing device is the main part of a sensor, and packaging is an important means for positioning the device. Moreover, as typical packaging of a pressure-sensing device can only directly measure gas pressure, when it is used in the measurement of a human pulse, an arterial pulse wave near the carpal joint can not be measured by direct contact, as in diagnosis by feeling the pulse by herbalist doctors. As a consequence, the pressure-sensing device must be further packaged, and a suitable pressure sensor mechanism must be added, so that the variation of blood vessel volume on the body surface caused by heartbeat and blood pressure can be determined by direct contact. And then the resulting deformation displacement can be linked to a center pressure-sensing device through a sensor mechanism, and further converted to an electrical signal via the impedance change of the sensing device. The obtained electrical signal is outputted for subsequent analysis and interpretation.

FIG. 1 depicts a sectional view of a conventional pressure sensor. The pressure sensor may be applied to measure a human pulse. This pressure sensor uses a liquid as the media of the sensor mechanism to transmit a signal. As shown in the FIG. 1, the pressure sensor is composed of a plastic frame 100, a pressure-sensing device 102, a stainless steel sheet 104, a liquid 106 and a bump 108. The plastic frame 100 includes a recessed portion 100a. The pressure-sensing device 102 is disposed in the recessed portion 100a of the plastic frame 100. The stainless steel sheet 104 covers the recessed portion 100a of the plastic frame 100. The liquid 106 is filled in the recessed portion 100a of the plastic frame 100. The bump 108 is disposed on the stainless steel sheet 104, and at least located above the pressure-sensing device 102.

During the fabrication of this pressure sensor, the stainless steel sheet 104 (about 10 μm in thickness) is attached to the plastic frame 100 with the pressure-sensing device 102. Subsequently, the liquid 106 is injected into the recessed portion 100a of the plastic frame 100 from the other side using a syringe.

However, it is very difficult to attach the stainless steel sheet (thickness of about 10 μm) to the plastic frame with a pressure-sensing device. Moreover, in subsequent processing and use, it is also possible that a slit is formed between the stainless steel sheet and the plastic frame leading to leakage of the injected liquid and a poor signal transmission. Thus, the problems of poor device performance and even device failure may occur.

### SUMMARY OF THE INVENTION

Accordingly, the present invention is directed to an encapsulation composition for pressure signal transmission and a sensor using the composition. According to the invention, the loss of signal transmission caused in later processing and use can be avoided. Moreover, the package formed from encapsulation composition is hydrophobic so the sensing device of the sensor can be further protected against moisture and thereby to extend its lifetime.

The present invention provides an encapsulation composition for pressure signal transmission comprising an epoxy resin, a curing agent and plastic balls. The epoxy resin is in an amount of 10-75% by weight of the composition. The curing agent is in an amount of 10-85% by weight of the composition. The plastic balls are in an amount of 5-80% by weight of the composition.

In the encapsulation composition for pressure signal transmission described above, the epoxy resin is selected from more than one of difunctional epoxy resins and multifunctional epoxy resins. The difunctional resins have a structure as shown in formula (I):

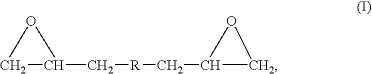

Wherein R represents bisphenol-A group, bisphenol-F group, bisphenol-S group, ester type or ether type group, and the epoxy equivalent of the difunctional resins has a molecular weight between 150 and 1500. The multifunctional epoxy resins have a structure as shown in formula (II):

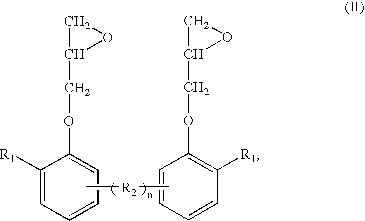

Wherein, R₁ represents H or CH₃; R₂ represents novolac group, cresol group, or dicyclopentadiene group; n represents an integer of 1-6.

In the encapsulation composition for pressure signal transmission described above, the epoxy resins includes four epoxy groups, having the a structure as shown in formula (III):

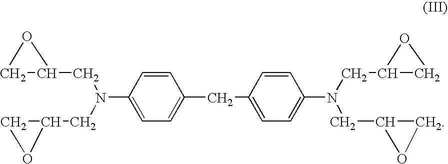

In the encapsulation composition for pressure signal transmission described above, the curing agents are those with difunctional group or multifunctional group. The curing agents contain a structure of poly(propylene glycol), and have a molecular weight between 150 and 5000.

In the encapsulation composition for pressure signal transmission described above, the yield strength of the material obtained by combining the curing agent with the epoxy resin is in the range of 0.05-80 MPa, preferably 0.5-20 MPa.

In the encapsulation composition for pressure signal transmission described above, the average particle size of the plastic balls is in the range of 1-100 μm. The material of the plastic balls includes polyacrylate, poly(methyl methacrylate), polystyrene, or a mixture thereof.

The encapsulation composition for pressure signal transmission of the invention employs a flexible and low modulus epoxy resin as a substance, in combination with plastic balls with pressure signal transmission properties as filler. The pressure signal is transmitted by utilizing the property of flexible deformation of the flexible epoxy resin under pressure. And the effect of signal transmission is further enhanced by the contact between the added plastic balls.

The encapsulation composition for pressure signal transmission of the invention can be used in a sensor device for transmitting pressure signal. The encapsulation composition is hydrophobic, so the electric device of the sensor can be further protected against moisture or water to extend its lifetime.

The present invention also provides a sensor, comprising a frame for support, a pressure sensing device and a package for pressure signal transmission. The frame for support has a recessed portion. The pressure-sensing device is disposed in the recessed portion of the frame for support. The package for pressure signal transmission covers the pressure-sensing device, and fills in the recessed portion of the frame for support, and protrudes out from the surface of the frame for support. The package for pressure signal transmission is composed of an encapsulation composition containing epoxy resin, a curing agent and plastic balls. The epoxy resin is in an amount of 10-75% by weight of the composition. The curing agent is in an amount of 10-85% by weight of the composition. The plastic balls are in an amount of 5-80% by weight of the composition.

In the sensor described above, the epoxy resin is selected from more than one of difunctional epoxy resins and multifunctional epoxy resins. The difunctional resins have the structure as shown in formula (I):

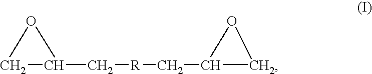

Wherein R represents bisphenol-A group, bisphenol-F group, bisphenol-S group, ester type or ether type group, and the molecular weight of the epoxy equivalent of the difunctional resins is between 150 and 500. The multifunctional epoxy resins have the structure as shown in formula (II):

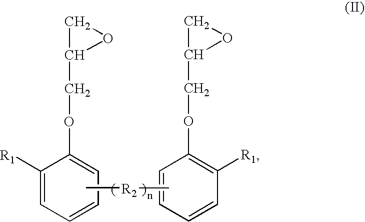

Wherein, R₁ represents H or CH₃; R₂ represents novolac group, cresol group, or dicyclopentadiene group; n represents an integer of 1-6.

In the sensor described above, the epoxy resins include four epoxy groups, having the a structure as shown in formula (III):

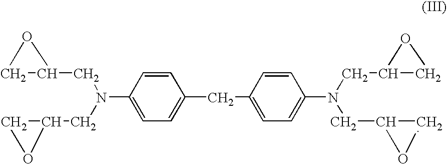

In the sensor described above, the curing agent contains a structure of poly(propylene glycol), and has a molecular weight between 150 and 5000.

In the sensor described above, the yield strength of the package for pressure signal transmission is in the range of 0.05-80 MPa, preferably 0.5-20 MPa.

In the sensor described above, the average particle size of the plastic balls is in a range of 1-100 μm. The plastic balls include polyacrylate, poly(methyl methacrylate) polystyrene, or a mixture thereof.

The package for pressure signal transmission of the invention employs a flexible and low modulus epoxy resin as a substance, in combination with plastic balls with pressure signal transmission properties as filler. The pressure signal is transmitted by utilizing the property of elastic deformation of the flexible epoxy resin under pressure. And the effect of signal transmission is further enhanced by the contact between the added plastic balls.

Moreover, the package for pressure signal transmission in the sensor is hydrophobic, so the electric device of the sensor can be further protected against moisture or water to extend its lifetime.

Furthermore, as the package for pressure signal transmission in the sensor has the features such as simple operation and easy processing, mass production can be applied, and thus this technology is highly desirable.

Additionally, compared with conventional sensors using a liquid for transmitting pressure signal, the sensor of the invention will not have the disadvantage of loss of signal transmission caused in subsequent processing and use, as in the case of the conventional sensors.

In order to make the aforementioned and other objects, features and advantages of the present invention comprehensible, the following preferred embodiments accompanied with figures are described in detail below.

### BRIEF DESCRIPTION OF THE DRAWINGS

FIG. 1 is a sectional structural view of a conventional pressure sensor.

FIG. 2 is a sectional structural view of the pressure sensor of the invention.

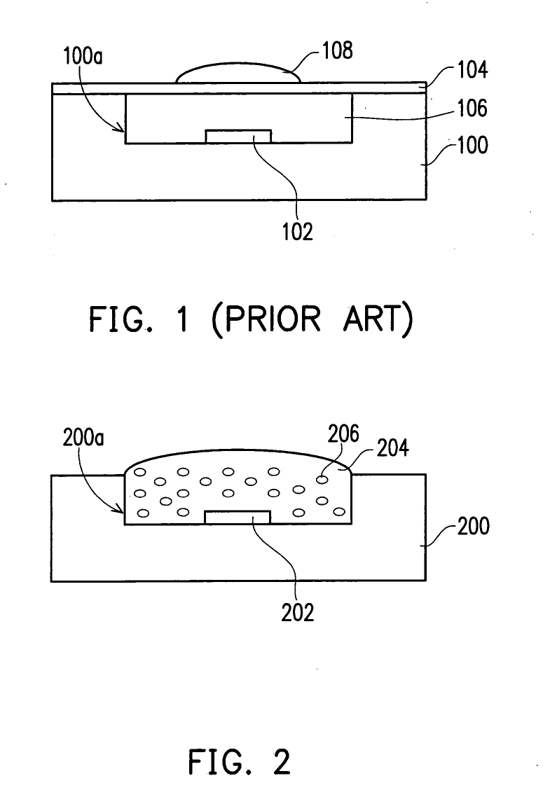

### DESCRIPTION OF EMBODIMENTS

The encapsulation composition for pressure signal transmission of the invention primarily includes an epoxy resin, a curing agent and plastic balls.

The epoxy resin is a flexible and low modulus epoxy resin. Moreover, the epoxy resin is, for example, difunctional epoxy resin, or multifunctional epoxy resin.

The difunctional epoxy resin has, for example, the structure as shown in formula (I):

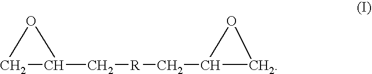

Wherein R represents bisphenol-A group, bisphenol-F group, bisphenol-S group, ester type or ether type group, and the molecular weight of the epoxy equivalent of the difunctional resin is between 150 and 1500.

The multifunctional epoxy resin has, for example, the structure as shown in formula (II):

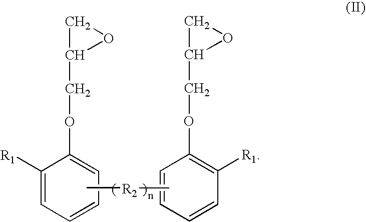

Wherein, R₁ represents H or CH₃; R₂ represents novolac group, cresol group, or dicyclopentadiene group; n represents an integer of 1-6.

For example, a resin having four epoxy groups includes the structure as shown in formula (III):

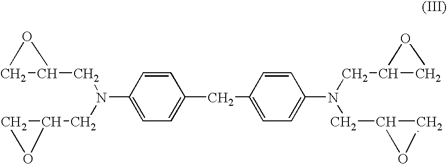

In the encapsulation composition for pressure signal transmission of the invention, the curing agent contains a difunctional group or multifunctional group. For example, the curing agent is, for example, has a structure of poly(propylene glycol). The molecular weight of the curing agent preferably is in the range of 150-5000.

In the encapsulation composition for pressure signal transmission of the invention, the yield strength of the material obtained by combining the curing agent with the epoxy resin is in the range of 0.05-80 MPa, preferably 0.5-20 MPa.

In the encapsulation composition for pressure signal transmission of the invention, the plastic balls possess the property of transmitting pressure, and will not damage a pressure-sensing device when contacting with the device. The material of the plastic balls includes polyacrylate, poly(methyl methacrylate) polystyrene, or a mixture thereof. Moreover, the average particle size of the plastic balls is in a range of 1-100 μm.

In the encapsulation composition for pressure signal transmission of the invention, the epoxy resin is in an amount of 10-75% by weight of the composition. The curing agent is in an amount of 10-85% by weight of the composition. The plastic balls are in an amount of 5-80% by weight of the composition.

The encapsulation composition for pressure signal transmission of the invention employs a flexible and low modulus epoxy resin as a substance, in combination with plastic balls with pressure signal transmission properties as filler. The pressure signal is transmitted by utilizing the property of elastic deformation of the flexible epoxy resin under pressure. And the effect of signal transmission is further enhanced by the contact between the added plastic balls.

The encapsulation composition for pressure signal transmission of the invention can be used in a sensor device for transmitting pressure signal. The encapsulation composition is hydrophobic, so the electric device of the sensor can be further protected against moisture or water to extend its lifetime.

The pressure sensor of the present invention is illustrated below. FIG. 2 depicts a sectional view of the pressure sensor of the invention.

As shown in the FIG. 2, the pressure sensor is composed of a frame 200 for support, a pressure-sensing device 202, and a package 204 for pressure signal transmission.

The frame 200 for support has a recessed portion 200a. The material of the frame 200 for support is, for example, plastic. The pressure-sensing device 202 is, for example, disposed in the recessed portion 200a of the frame 200 for support. The package 204 for pressure signal transmission, for example, covers the pressure-sensing device 202, and fills in the recessed portion 200a of the frame 200 for support, and protrudes out from the surface of the frame 200 for support. The package 204 for pressure signal transmission is, for example, composed of the encapsulation composition of the invention, with plastic balls 206, for example, being dispersed in the package 204.

The following experimental examples 1˜3 and comparative examples 1˜2 are illustrated to demonstrate the effect of the encapsulation composition for pressure signal transmission of the invention, but the invention is not limited to the following experimental examples.

In the following experimental examples 1˜3 and comparative examples 1˜2, epoxy resin is diglycidyl ether of bisphenol-A (DGEBA) (Trade Name: EPON-828, made by SHELL CHEMICAL Co.). The curing agent A is poly(propylene glycol) bis(2-aminopropyl ether) (Trade Name: Jeffamine®D-400, made by HUNTSMAN Co.). The curing agent B is poly (propylene glycol) bis (2-aminopropyl ether) (Trade Name: Jeffamine®D-2000, made by HUNTSMAN Co.). The material of the plastic balls is poly(methyl methacrylate) (Trade Name: MX-1500H, made by SOKEN CHEMICAL & ENGINEERING Co.).

### EXPERIMENTAL EXAMPLE 1

5.64 g epoxy resin, 2.5 g of the curing agent A, 2.5 g of the curing agent B and 2.5 g PMMA plastic balls were added into a 500 ml beaker. The mixture was stirred at room temperature for 10 minutes and degassed in a vacuum oven for 30 minutes to prepare an encapsulation composition with pressure signal transmission properties.

### EXPERIMENTAL EXAMPLE 2

5.64 g epoxy resin, 2.5 g of the curing agent A, 2.5 g of the curing agent B and 7.5 g PMMA plastic balls were added into a 500 ml beaker. The mixture was stirred at room temperature for 10 minutes and degassed in a vacuum oven for 30 minutes to prepare an encapsulation composition with pressure signal transmission properties.

### EXPERIMENTAL EXAMPLE 3

8.46 g epoxy resin, 2.5 g of the curing agent A, 10 g of the curing agent B and 21 g PMMA plastic balls were added to a 500 ml beaker. The mixture was stirred at room temperature for 10 minutes and degassed in a vacuum oven for 30 minutes to prepare an encapsulation composition with pressure signal transmission properties.

### COMPARATIVE EXAMPLE 1

5.64 g epoxy resin, 2.5 g of the curing agent A, and 2.5 g of the curing agent B were added to a 500 ml beaker. The mixture was uniformly stirred at a room temperature for 10 minutes and degassed in a vacuum oven for 30 minutes to prepare an encapsulation composition.

### COMPARATIVE EXAMPLE 2

5.64 g epoxy resin and 15 g of the curing agent B were added into a 500 ml beaker. The mixture was uniformly stirred at room temperature for 10 minutes and degassed in a vacuum oven for 30 minutes to prepare an encapsulation composition.

Thereafter, after the preparation of the compositions of the experimental examples 1˜3 and comparative examples 1˜2, the compositions were respectively casted into a sensor device to be packaged, and were cured to make samples. Then, simulative pulse wave measurements were carried out on the samples, to evaluate sensing properties of the sensor devices manufactured from the compositions of the experimental examples 1˜3 and comparative examples 1˜2 on contacting deformation. The proportions and related physical properties of the compositions of experimental examples 1˜3 and comparative examples 1˜2 were listed in Table 1.

The simulative pulse wave measurement is illustrated herein. The simulative pulse wave measurement system directly contacts with a packaged pressure-sensing device mainly through a precise displaceable mechanical device. And then the resulting deformation displacement via contact may be linked to a center pressure-sensing device through a sensor mechanism, and further converted to an electrical signal via the impedance change of the sensing device. The obtained electrical signal is outputted for subsequent analysis and interpretation to simulate the variation of the blood vessel volume on the body surface. During the simulative pulse wave measurement, the displacement of the mechanical device is set at 50 micron meters, and the voltage differences of the sensor devices manufactured from the combinations of the experimental examples 1˜3 and comparative examples 1˜2 are measured.

TABLE 1

| | | Curing | Curing | Plastic | Displacement | Voltage |
|---|---|---|---|---|---|---|
| | Epoxy | Agent | Agent | Ball | Micron | Difference |
| | Resin | A | B | PMMA | Meters (μm) | (mV) |
| Embodiment 1 | 5.64 | 2.5 | 2.5 | 2.5 | 50 | 30 |
| Embodiment 2 | 5.64 | 2.5 | 2.5 | 7.5 | 50 | 45 |
| Embodiment 3 | 8.46 | 2.5 | 10 | 21 | 50 | 55 |
| Comparative | 5.64 | 2.5 | 2.5 | — | 50 | 15 |
| Example 1 | | | | | | |
| Comparative | 5.64 | — | 15 | — | 50 | 0 |
| Example 2 | | | | | | |

As seen the results in the Table 1, the voltage differences of the packages manufactured from the encapsulation compositions of the experimental examples 1˜3 are greater than that of the packages manufactured from the encapsulation compositions of comparative examples 1˜2, indicating that the package manufactured from the encapsulation composition of the invention has a better pressure transmission effect.

The package of the sensor of the invention employs a flexible and low modulus epoxy resin as a substance, in combination with plastic balls with pressure signal transmission properties as filler. The pressure signal is transmitted by utilizing the property of easy deformation of the flexible epoxy resin under pressure. And the effect of signal transmission is further enhanced by the contact between the added plastic balls.

Moreover, the package in the sensor is hydrophobic, so the sensing device can be further protected against moisture or water to extend its lifetime.

Furthermore, as the package for pressure signal transmission in the sensor has properties such as simple operation and easy processing, automatic production can be applied in the packaging process, and thus this becomes a crucial production technology.

Additionally, compared with conventional sensors using a liquid for transmitting pressure signals, the sensor of the invention will not have the disadvantage of loss of signal transmission caused in subsequent processing and use, as in the case of the conventional sensors.

Although the present invention has been disclosed with preferred embodiments above, these are not intended to limit the invention. It will be apparent to those skilled in the art that various modifications and variations can be made to the present invention without departing from the scope or spirit of the invention. Therefore, the application scope of the invention is only defined by the following claims.

What is claimed is:

1. An encapsulation composition for pressure signal transmission, comprising:
an epoxy resin, in an amount of 10-75% by weight of the composition;
a curing agent, in an amount of 10-85% by weight of the composition; and
plastic balls, in an amount of 5-80% by weight of the composition.

2. The encapsulation composition for pressure signal transmission as claimed in claim 1, wherein said epoxy resin comprises at least one of difunctional epoxy resin and multifunctional epoxy resin.

3. The encapsulation composition for pressure signal transmission as claimed in claim 2, wherein said difunctional resins have a structure as shown in formula (I): 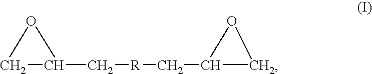
wherein R represents bisphenol-A group, bisphenol-F group, bisphenol-S group, ester type or ether type group, and epoxy equivalent of said difunctional resins is between 150 and 1500.

4. The encapsulation composition for pressure signal transmission as claimed in claim 2, wherein said multifunctional epoxy resins have a structure as shown in formula (II): 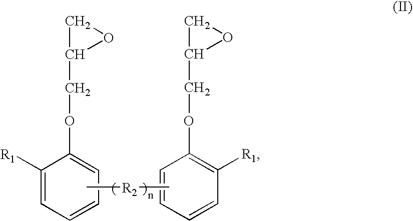
R₁ represents H or CH₃; R₂ represents novolac group, cresol group, or dicyclopentadiene group; n represents an integer of 1-6.

5. The encapsulation composition for pressure signal transmission as claimed in claim 2, wherein said epoxy resins comprise a resin having four epoxy groups, and has a structure as shown in formula (III):

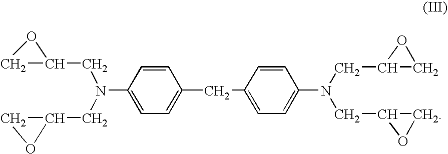

6. The encapsulation composition for pressure signal transmission as claimed in claim 1, wherein said curing agent comprises a difunctional group or a multifunctional group.

7. The encapsulation composition for pressure signal transmission as claimed in claim 6, wherein said curing agent contains a structure of a poly(propylene glycol), and has a molecular weight between 150 and 5000.

8. The encapsulation composition for pressure signal transmission as claimed in claim 1, wherein the yield strength of the material obtained by combining said curing agent with said epoxy resin is in the range of 0.05-80 MPa.

9. The encapsulation composition for pressure signal transmission as claimed in claim 1, wherein the yield strength of the material obtained by combining said curing agent with said epoxy resin is preferably in the range of 0.5-20 MPa.

10. The encapsulation composition for pressure signal transmission as claimed in claim 1, wherein an average particle size of said plastic balls is in the range of 1-100 μm.

11. The encapsulation composition for pressure signal transmission as claimed in claim 1, wherein said plastic balls comprise polyacrylate, poly(methyl methacrylate), polystyrene, or a mixture thereof.

12. A sensor, comprising:
a frame for support, having a recessed portion;
a pressure sensing device, disposed in said recessed portion of said frame for support; and
a package, for pressure signal transmission, covering said pressure sensing device and filling in said recessed portion of said frame for support, and protruding out from a surface of said frame for support, said package for pressure signal transmission being composed of an encapsulation composition, said encapsulation composition comprises:
an epoxy resin, in an amount of 10-75% by weight of the composition;
a curing agent, in an amount of 10-85% by weight of the composition; and
plastic balls, in an amount of 5-80% by weight of the composition.

13. The sensor as claimed in claim 12, wherein said epoxy resin comprises at least one of difunctional epoxy resin and multifunctional epoxy resin.

14. The sensor as claimed in claim 13, wherein said difunctional resins have a structure as shown in formula (I): 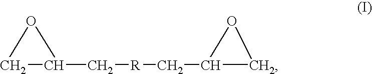
wherein R represents bisphenol-A group, bisphenol-F group, bisphenol-S group, ester group, or ether group, and a epoxy equivalent of said difunctional resins is between 150 and 1500; and
said multifunctional epoxy resins have a structure as shown in formula (II): 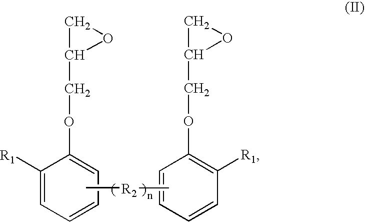
R₁ represents H or CH₃, R₂ represents novolac group, cresol group, or dicyclopentadiene group, and n represents an integer of 1-6.

15. The sensor as claimed in claim 12, wherein said epoxy resins comprise resin having four epoxy groups, and have structure as shown in formula (III):

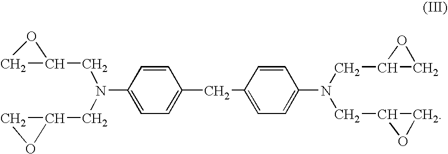

16. The sensor as claimed in claim 12, wherein said curing agent contains a structure of a poly(propylene glycol), and has a molecular weight between 150 and 5000.

17. The sensor as claimed in claim 12, wherein yield strength of said package for pressure signal transmission is in a range of 0.05-80 MPa.

18. The sensor as claimed in claim 12, wherein yield strength of said package for pressure signal transmission is preferably in a range of 0.5-20 MPa.

19. The sensor as claimed in claim 12, wherein an average particle size of said plastic balls is in a range of 1-100 μm.

20. The sensor as claimed in claim 12, wherein the material of said plastic balls includes polyacrylate, poly(methyl methacrylate), polystyrene, or a mixture thereof.
